(19) United States
(12) Patent Application Publication
(10) Pub. No.: US 2010/0026672 A1
(43) Pub. Date: Feb. 4, 2010

(54) CIRCUIT FOR DRIVING A PLASMA DISPLAY PANEL

(76) Inventor: Yoo-Jin Song, Suwon-si (KR)

Correspondence Address: CHRISTIE, PARKER & HALE, LLP, PO BOX 7068, PASADENA, CA, 91109-7068, US

(21) Appl. No.: 12/413,172

(22) Filed: Mar. 27, 2009

Related U.S. Application Data
(60) Provisional application No. 61/085,728, filed on Aug. 1, 2008.

(51) Int. Cl. G09G 5/00

(52) U.S. Cl. 345/211; 345/204; 345/60

(57) ABSTRACT

A plasma display panel (PDP) with reduced switching loss when the PDP is driven at a high frequency. The PDP includes a first electrode, a second electrode parallel to the first electrode, and a third electrode crossing the first electrode and the second electrode, and a driver for applying a plurality of sustain pulses at a sustain frequency to the first electrode during a sustain period. The driver includes a first driving circuit for applying a first portion of the plurality of sustain pulses to the first electrode and a second driving circuit for applying a second portion of the plurality of sustain pulses to the first electrode. The first portion and the second portion of the plurality of sustain pulses have the same polarity, and the first driving circuit and the second driving circuit are configured to apply the first portion and the second portion, respectively, at different time.

### CROSS-REFERENCE TO RELATED APPLICATIONS

This application claims priority to and the benefit of U.S. Provisional Patent Application No. 61/085,728, filed on Aug. 1, 2008, the entire content of which is incorporated herein by reference.

### BACKGROUND

1. Field of the Invention

The present invention relates to a circuit for driving a plasma display panel (PDP), and more particularly, to a circuit for driving a PDP with reduced switching loss.

2. Discussion of Related Art

A PDP emits light from phosphors excited by ultraviolet (UV) rays of, for example, 147 nm generated during the discharge of an inert gas mixture in the discharge cells of the PDP, and displays an image including characters and/or graphics. The PDP has both a thin profile and a large display area, and can display an image with improved picture quality due to recent technological developments.

In a method of driving a typical PDP, one frame is divided into a plurality of sub frames. Each of the plurality of sub frames includes a reset period, an address period, and a sustain period. In the reset period, the wall charge states of the discharge cells are initialized. In the address period, cells for emitting light in the sustain period are selected among the plurality of discharge cells. In the sustain period, the cells that are selected in the address period emit light.

In the sustain period, sustain pulses having a voltage of several hundred volts are alternately supplied to scan electrodes Y and sustain electrodes X at a frequency of several hundreds of KHz. When the sustain pulses are supplied, the PDP suffers a large amount of energy loss. In order to minimize the loss of energy, the PDP may include an energy recovery circuit. The energy recovery circuit recovers energy charged in the discharge cells and re-supplies the recovered energy when a next sustain pulse is supplied to minimize the loss of energy.

In addition, in order to supply the sustain pulses to the scan electrodes Y and the sustain electrodes X in the sustain period, the driving circuit coupled to the electrodes needs to handle a high current flow. As the size of the PDP increases, the magnitude of the current that flows through the driving circuit increases. When the magnitude of the current that flows through the driving circuit increases, the internal voltage and the heat generation of the elements in the driving circuit increase.

In order to handle high current, the sustain switch (coupled to a sustain power source) and the ground switch (coupled to a ground power source) included in the energy recovery circuit are each formed by coupling a plurality of switches in parallel to each other. When the plurality of switches are coupled to a current path in parallel to form the sustain switch and the ground switch, the current handling capacity increases, however, switching loss also increases. That is, when the switches are coupled to the current path in parallel, the parasitic capacitance of the switches increases. Furthermore, when the sustain frequency is increased in order to realize high picture quality, the increase in the parasitic capacitance of the switches causes a significant increase in switching loss. Therefore, it is desirable to provide an improved driving circuit with increased current handling capacity and reduced switching loss when the PDP is driven at a high frequency.

Furthermore, it is desirable to design the circuit for driving the PDP to be realized at a low cost. In the conventional art, in order to drive the PDP at the high frequency, expensive elements capable of driving the PDP at the high frequency must be used at the respective stages of the driving circuit. Therefore, it is desirable to design a new driving circuit that can be manufactured at a low cost yet capable of driving the PDP at the high frequency.

### SUMMARY OF THE INVENTION

Accordingly, it is an aspect of the present invention to provide a plasma display panel (PDP) with reduced switching loss when the PDP is driven at a high frequency.

It is another aspect of the present invention to provide a driving circuit for driving a PDP at a high frequency without increasing its manufacturing cost.

According to an embodiment of the present invention, a plasma display device includes a first electrode, a second electrode parallel to the first electrode, and a third electrode crossing the first electrode and the second electrode, and a driver for applying a plurality of sustain pulses at a sustain frequency to the first electrode during a sustain period. The driver includes a first driving circuit for applying a first portion of the plurality of sustain pulses to the first electrode and a second driving circuit for applying a second portion of the plurality of sustain pulses to the first electrode. The first portion and the second portion of the plurality of sustain pulses have the same polarity, and the first driving circuit and the second driving circuit are configured to apply the first portion and the second portion, respectively, at different time.

The first driving circuit and the second driving circuit may be configured to apply the first portion and the second portion, respectively, at frequencies less than the sustain frequency.

Each of the first driving circuit and the second driving circuit may include a first switch having a first terminal coupled to a first power and a second terminal coupled to the first electrode, and a second switch having a first terminal coupled to the first electrode and a second terminal coupled to a second power.

The first power may provide a sustain voltage. The second power may provide a ground voltage.

The driver may further include a first energy recovery circuit coupled to the first electrode.

The first energy recovery circuit may include a capacitor having a first terminal coupled to a ground voltage and a second terminal, an inductor having a first terminal coupled to the first electrode and a second terminal, a first switch having a first terminal coupled to the second terminal of the capacitor and a second terminal coupled to the second terminal of the inductor, and a second switch having a first terminal coupled to the second terminal of the inductor and a second terminal coupled to the second terminal of the capacitor.

The first energy recovery circuit may include a capacitor having a first terminal coupled to a ground voltage and a second terminal, an inductor having a first terminal coupled to the second terminal of the capacitor and a second terminal, a first switch having a first terminal coupled to the second terminal of the inductor and a second terminal coupled to the first electrode, and a second switch having a first terminal coupled to the second terminal of the inductor and a second terminal coupled to the first electrode.

The first energy recovery circuit may be coupled to the first electrode through each of the first and second driving circuits.

The first portion and the second portion of the plurality of sustain pulses may be alternately applied to the first electrode.

The driver may further include a second energy recovery circuit coupled to the first electrode.

The second energy recovery circuit may have a substantially same circuit constitution as the first energy recovery circuit, and the first energy recovery circuit and the first driving circuit may be configured to generate the first portion of the plurality of sustain pulses.

The second energy recovery circuit and the second driving circuit may be configured to generate the second portion of the plurality of sustain pulses.

According to another embodiment of the present invention, a method of driving a plasma display device in a sustain period at a sustain frequency is provided. The plasma display device includes a first electrode, a second electrode parallel to the first electrode, and a third electrode crossing the first electrode and the second electrode. The method includes applying a first sustain pulse generated from a first driving circuit of the plasma display device to a first electrode, applying a second sustain pulse generated from a second driving circuit of the plasma display device to the first electrode, the second sustain pulse applied to the first electrode at a time different from that of the first sustain pulse. The first sustain pulse and the second sustain pulse have the same polarity.

The method may further include applying the first sustain pulse to the first electrode during the sustain period at a first frequency that is less than the sustain frequency, and applying the second sustain pulse to the first electrode during the sustain period at a second frequency that is less than the sustain frequency.

A summation of the first frequency and the second frequency may be equal to the sustain frequency. Each of the first frequency and the second frequency may be equal to one half of the sustain frequency. The first frequency may be equal to the second frequency. The first sustain pulse and the second sustain pulse may be alternately applied to the first electrode.

According to yet another embodiment of the present invention, a plasma display device includes a first electrode, a second electrode parallel to the first electrode, a third electrode crossing the first electrode and the second electrode, and a driver for applying a plurality of sustain pulses at a sustain frequency to the first electrode during a sustain period. The driver includes a first driving circuit for applying a first portion of the plurality of sustain pulses to the first electrode; and a second driving circuit for applying a second portion of the plurality of sustain pulses to the first electrode, the second portion applied to the first electrode at a time different from that of the first portion. The first driving circuit and the second driving circuit are coupled in parallel with respect to the first electrode.

An output voltage range of the first driving circuit may be substantially equal to that of the second driving circuit. The first driving circuit and the second driving circuit may be non-switchably coupled to the first electrode.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic drawing illustrating a perspective view of the structure of a discharge cell of a plasma display panel (PDP);

FIG. 2 is a schematic block diagram illustrating a PDP according to an embodiment of the present invention;

FIG. 3 is a schematic diagram illustrating waveforms of a subfield of the PDP according to an embodiment of the present invention;

FIG. 4A is a schematic circuit diagram illustrating an energy recovery circuit according to an embodiment of the present invention;

FIG. 4B is a schematic circuit diagram illustrating an energy recovery circuit according to an embodiment of the present invention;

FIG. 5 is a schematic diagram illustrating waveforms that describe a method of driving the energy recovery circuits of FIGS. 4A and 4B;

FIG. 6 is a schematic diagram illustrating sustain pulses supplied by the energy recovery circuits of FIGS. 4A and 4B;

FIG. 7A is a schematic circuit diagram illustrating an energy recovery circuit according to an embodiment of the present invention; and

FIG. 7B is a schematic circuit diagram illustrating an energy recovery circuit according to an embodiment of the present invention.

### DETAILED DESCRIPTION OF EXEMPLARY EMBODIMENTS

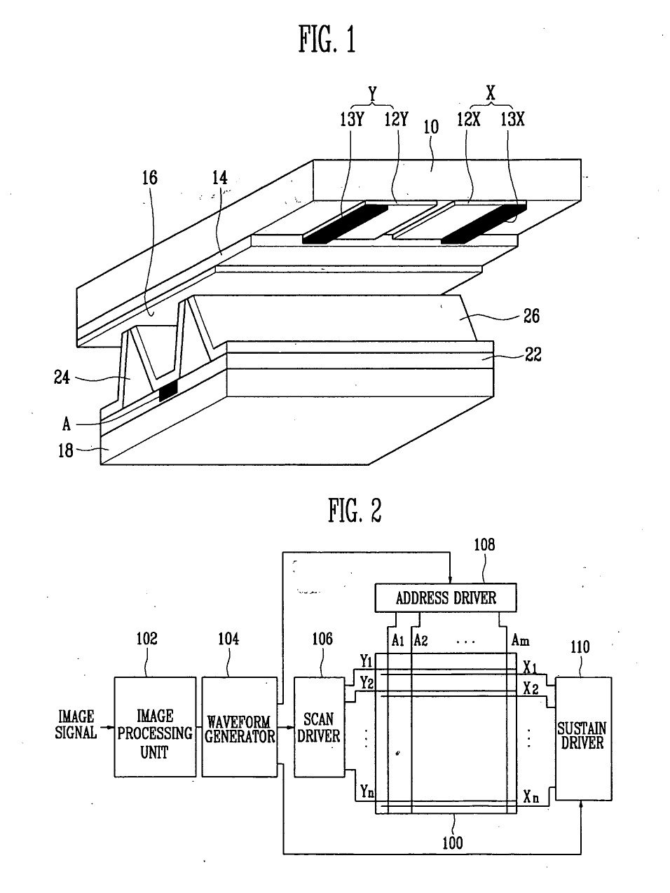

Hereinafter, exemplary embodiments of the present invention will be described in detail as follows with reference to the accompanying drawings of FIGS. 1 to 7B.

FIG. 1 is a schematic diagram illustrating a discharge cell of a plasma display panel (PDP) according to an embodiment of the present invention.

Referring to FIG. 1, the discharge cell of the conventional PDP corresponds to a scan electrode Y and a sustain electrode X formed on an upper substrate 10 and an address electrode A formed on a lower substrate 18. The scan electrode Y and the sustain electrode X include transparent electrodes 12Y and 12X and metal bus electrodes 13Y and 13X, respectively. The metal bus electrodes 13Y and 13X have a smaller width than the width of the transparent electrodes 12Y and 12X, and are formed at edges of the transparent electrodes 12Y and 12X, respectively. An upper dielectric layer 14 and a protective layer 16 are laminated on the upper substrate 10 where the scan electrode Y and the sustain electrode X extend in parallel.

A lower dielectric layer 22 and barrier ribs 24 are formed on the lower substrate 18 where the address electrode A is formed. A phosphor layer 26 is coated on the surface of the lower dielectric layer 22 and the barrier ribs 24. The address electrode A is formed to cross the scan electrode Y and the sustain electrode X. The barrier ribs 24 may be formed in a stripe pattern and/or a mesh pattern. The phosphor layer 26 is excited by ultraviolet (UV) rays generated during a plasma discharge to generate one of red, green, or blue visible light. An inert gas mixture is injected into the discharge spaces provided between the upper and lower substrates 10 and 18 and the barrier ribs 24.

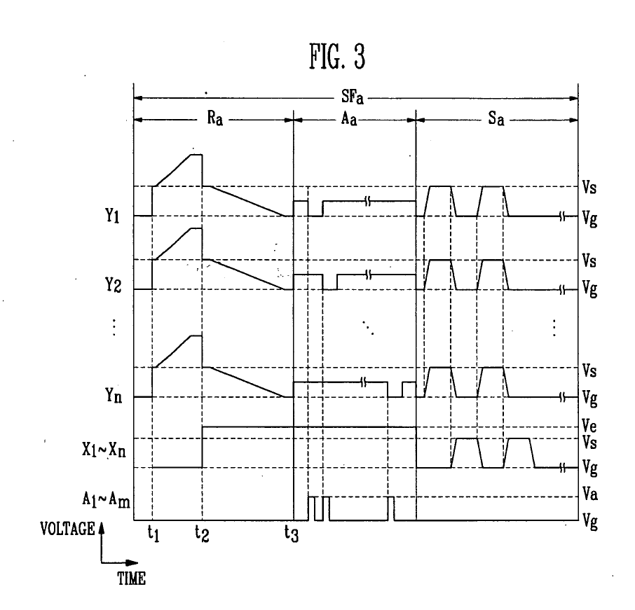

FIG. 2 schematically illustrates a block diagram of a PDP according to an embodiment of the present invention.

Referring to FIG. 2, the PDP according to the embodiment of the present invention includes a plasma display panel 100, an address driver 108, a scan driver 106, a sustain driver 110, a waveform generator 104, and an image processing unit 102.

The image processing unit 102 receives an analog image signal from the outside. The image processing unit 102 converts the analog image signal into a digital image signal. In addition, the image processing unit 102 generates a vertical synchronization signal, a horizontal synchronization signal and clock signals, and supplies the generated signals to the waveform generator 104.

The waveform generator 104 receives the digital image signal, the vertical synchronization signal, the horizontal synchronization signal, and the clock signals. The waveform generator 104 divides the digital image signal per each subfield and supplies the divided image signal to the address driver 108. In addition, the waveform generator 104 generates control signals in response to the vertical synchronization signal, the horizontal synchronization signal and the clock signals, and supplies the generated control signals to the scan driver 106, the address driver 108, and the sustain driver 110.

The address driver 108 generates data signals in response to the digital image signal and the control signals supplied thereto, and supplies the generated data signals to the address electrodes A1 to Am in the address period of the subfield.

The scan driver 106 generates scan signals in response to the control signals supplied thereto and supplies the generated scan signals to the scan electrodes Y1 to Yn in the address period of the subfield. Here, the scan signals can be supplied to the scan electrodes Y1 to Yn by various methods. For example, the scan driver 106 can sequentially supply the scan signals to the scan electrodes Y1 to Yn. In addition, the scan driver 106 may sequentially supply the scan signals to some scan electrodes (for example, odd scan electrodes) among the scan electrodes Y1 to Yn, then the scan driver 106 may sequentially supply the scan signals to the remaining scan electrodes (for example, even scan electrodes). In addition, the scan driver 106 may supply ramp pulses to the scan electrodes Y1 to Yn in the reset period of the subfield and supplies sustain pulses in a sustain period. The scan driver 106 includes an energy recovery circuit for supplying the sustain pulses.

The sustain driver 110 supplies the sustain pulses to the sustain electrodes X1 to Xn in response to the control signals supplied thereto. The sustain driver 110 and the scan driver 106 alternately apply the sustain pulses to the sustain electrodes X1 to Xn and the scan electrodes Y1 to Yn, respectively, in the sustain period. The sustain driver 110 includes the energy recovery circuit for supplying the sustain pulses.

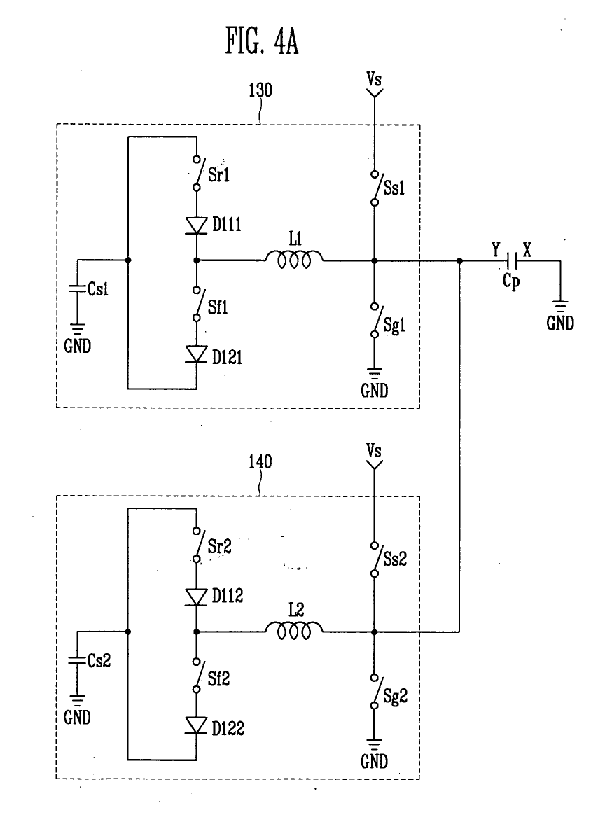

FIG. 3 is a schematic diagram illustrating waveforms for describing a method of driving the PDP according to an embodiment of the present invention. FIG. 3 only illustrates driving waveforms supplied in one subfield among the plurality of subfields included in one frame for the convenience of description.

Referring to FIG. 3, the subfield according to the embodiment of the present invention is divided into a reset period Ra, an address period Aa, and a sustain period Sa.

In the reset period Ra, ramp pulses that rise with a slope (e.g., a predetermined slop) are supplied to the scan electrodes Y1 to Yn in the wall charge accumulating period t1 to t2 while ground potential Vg is applied to the sustain electrodes X1 to Xn and the address electrodes A1 to Am. Ramp pulses that fall with a slope (e.g., a predetermined slop) are supplied to the scan electrodes Y1 to Yn while a voltage Ve (e.g., a predetermined voltage) is applied to the sustain electrodes X1 to Xn in wall charge distributing period t2 to t3. The ground potential Vg is applied to the address electrodes A1 to Am in the wall charge distributing period t2 to t3.

In the address period Aa, the scan signals are supplied to the scan electrodes Y1 to Yn, and the data signals synchronized with the scan signals are supplied to the address electrodes A1 to Am.

In the sustain period Sa, the sustain pulses are alternately applied to the scan electrodes Y1 to Yn and the sustain electrodes X1 to Xn. Then, the wall charges of the discharge cells selected by address discharges are added to the voltage of the sustain pulses so that sustain discharges are generated between the scan electrodes Y (e.g., Y1 to Yn) and the sustain electrodes X (e.g., X1 to Xn) when the sustain pulses are applied.

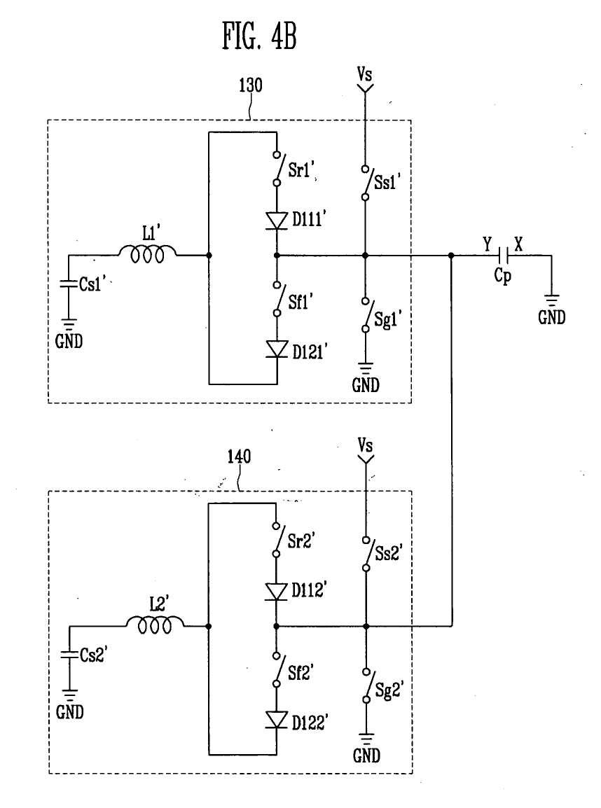

FIG. 4A is a schematic circuit diagram illustrating a circuit for driving the scan electrodes according to an embodiment of the present invention. For convenience of description, description of the structure of a circuit for generating the waveforms applied to the scan electrodes Y in the reset period and the address period is omitted. For convenience of description, description of a circuit for driving the sustain electrodes X is omitted. Although not shown, the driving circuit coupled to the sustain electrodes X may have the same or similar structure as the circuit coupled to the scan electrodes Y.

Referring to FIG. 4A, the driving circuit according to an embodiment of the present invention includes a first sustain driving circuit 130 and a second sustain driving circuit 140. The first sustain driving circuit 130 and the second sustain driving circuit 140 alternately supply the sustain pulses to the scan electrodes Y.

Each of the first sustain driving circuit 130 and the second sustain driving circuit 140 includes a rising switch (Sr1 or Sr2) and a falling switch (Sf1 or Sf2) coupled between an inductor (L1 or L2) and a source capacitor (Cs1 or Cs2) in parallel, a sustain switch (Ss1 or Ss2) coupled between a panel capacitor Cp and a sustain power source Vs, a ground switch (Sg1 or Sg2) coupled between the panel capacitor Cp and a ground power source GND, and the inductor (L1 or L2) coupled between a common terminal between the rising switch (Sr1 or Sr2) and the falling switch (Sf1 or Sf2) and the panel capacitor Cp.

In addition, a first diode (D111 or D112) is coupled between the rising switch (Sr1 or Sr2) and the inductor (L1 or L2) so that a current can be supplied from the rising switch (Sr1 or Sr2) to the inductor (L1 or L2), and a second diode (D121 or D122) is coupled between the falling switch (Sf1 or Sf2) and the source capacitor (Cs1 or Cs2) so that a current can be supplied from the falling switch (Sf1 or Sf2) to the source capacitor (Cs1 or Cs2). In some embodiments of the present invention, the positions of the failing switch (Sf1 or Sf2) and the second diode (D121 or D122) can be changed. For example, the second diode (D121 or D122) can be positioned between the inductor (L1 or L2) and the falling switch (Sf1 or Sf2).

The panel capacitor Cp represents an electrostatic capacity or capacitance formed in the discharge cell. The rising switch (Sr1 or Sr2) is turned on when the voltage charged in the source capacitor (Cs1 or Cs2) is supplied to the panel capacitor Cp. The falling switch (Sf1 or Sf2) is turned on when the voltage charged in the panel capacitor Cp is recovered to the source capacitor (Cs1 or Cs2). The sustain switch (Ss1 or Ss2) is turned on when the sustain voltage Vs is supplied to the panel capacitor Cp. The ground switch (Sg1 or Sg2) is turned on when the ground power source GND is supplied to the panel capacitor Cp. The inductor (L1 or L2) forms a resonance circuit with the panel capacitor Cp.

In the embodiment shown in FIG. 4A, the first sustain driving circuit 130 and the second sustain driving circuit 140 are formed of the same circuit components. However, the present invention is not limited to the above described embodiment. For example, the components of the first sustain driving circuit 130 and the second sustain driving circuit 140 may have different values. Therefore, the first sustain driving circuit 130 and the second sustain driving circuit 140 may alternately apply different sustain waveforms to the scan electrodes Y (or sustain electrodes X). Furthermore, those skilled in the art will understand that the sustain driving circuits 130 and 140 may have other suitable circuit configurations within the scope of the present invention as long as the sustain driving circuits 130 and 140 can perform an energy recovery operation and a sustain operation.

FIG. 4B is a schematic circuit diagram illustrating a circuit for driving the scan electrodes according to an embodiment of the present invention. The differences between the embodiments shown in FIG. 4A and FIG. 4B are the relative locations of the rising switches (Sr1, Sr2, Sr1′ and Sr2′), the falling switches (Sf1, Sf2, Sf1′ and Sf2′) and the inductors (L1, L2, L1′ and L2′). Since the embodiment shown in FIG. 4B operates under substantially the same principles as the embodiment shown in FIG. 4A, a detailed description of the operations of the embodiment shown in FIG. 4B will be omitted.

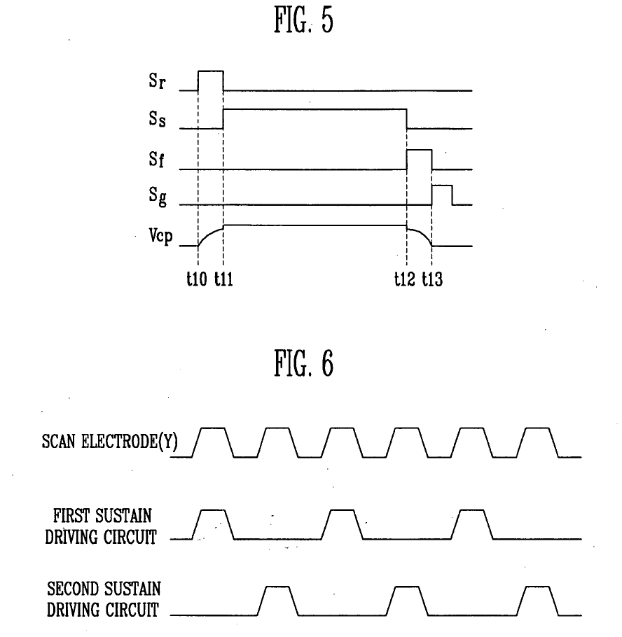

FIG. 5 illustrates the operations of the circuits for driving the PDP of FIGS. 4A and 4B. In FIG. 5, for convenience of description, the operations of the driving circuit will be described using only the first sustain driving circuit 130. Here, the operations will be described with the assumption that the voltage of Vs/2 is charged in the source capacitor Cs (e.g., Cs1, Cs2, Cs1′ or Cs2′).

First, the rising switch Sr (e.g., Sr1, Sr2, Sr1′ or Sr2′) is turned on at the point of time t10. When the rising switch Sr is turned on, the voltage stored in the source capacitor Cs is supplied to the panel capacitor Cp through the rising switch Sr, the first diode (e.g., D111, D112, D111′ or D112′), and the inductor L (e.g., L1, L2, L1′ or L2′). At this time, the inductor L and the panel capacitor Cp form an LC resonance circuit. In this case, the voltage of Vs/2 stored in the source capacitor Cs increases to the voltage of about Vs by the LC resonance circuit and is supplied to the panel capacitor Cp.

The sustain switch Ss (e.g., Ss1, Ss2, Ss1′ or Ss2′) is turned on at the point of time t11. When the sustain switch Ss is turned on, the voltage of the sustain power source Vs is supplied to the panel capacitor Cp through the sustain switch Ss. Here, since the voltage of about Vs is charged in the panel capacitor Cp at the point of time immediately before t11, the energy supplied by the sustain power source Vs is minimized. On the other hand, the panel capacitor Cp is sustained at the sustain voltage Vs from the point of time t11 to the point of time t12. Here, a period between the point of time t11 and the point of time t12 may be experimentally determined so that a stable sustain discharge is generated.

The falling switch Sf (e.g., Sf1, Sf2, Sf1′ or Sf2′) is turned on at the point of time t12. When the falling switch Sf is turned on, the voltage charged in the panel capacitor Cp is recovered by the source capacitor Cs through the inductor L, the falling switch Sf, and the second diode (e.g., D121, D122, D121′ or D122′).

The ground switch Sg (e.g., Sg1, Sg2, Sg1′ or Sg2′) is turned on at the point of time t13. When the ground switch Sg is turned on, the ground voltage GND is supplied to the panel capacitor Cp.

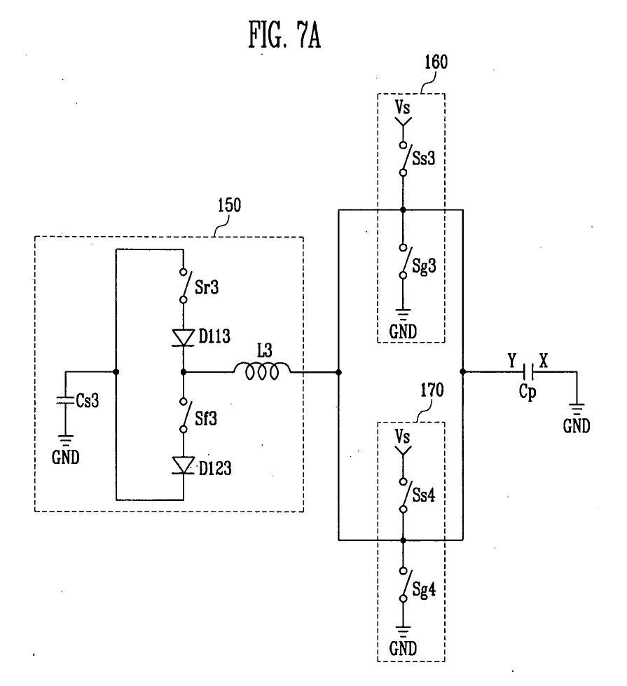

FIG. 6 is a schematic diagram illustrating sustain waveforms according to an embodiment of the present invention. According to the embodiment of FIG. 6, the first recovery circuit 130 and the second recovery circuit 140 repeat the above-described operations in reference to FIG. 5 to alternately supply the sustain pulses to the scan electrodes Y as illustrated in FIG. 6. As described above, when the first recovery circuit 130 and the second recovery circuit 140 are alternately driven to supply the sustain pulses, their switching frequencies are 1/2 of that of the sustain pulses applied to the scan electrodes Y so that their switching losses can be minimized or reduced.

For example, when the sustain pulses must be supplied at a frequency of 200 KHz, the first sustain driving circuit 130 and the second sustain driving circuit 140 are each driven at a switching frequency of 100 KHz to alternately supply the sustain pulses. Therefore, their switching losses can be minimized or reduced.

Furthermore, although the circuit for driving the sustain electrodes X is not illustrated in the drawings, the circuit for driving the sustain electrodes X can be designed to have the same structure as the circuit for driving the scan electrodes Y. According to an exemplary embodiment, the circuit for driving the sustain electrodes X may include two sustain driving circuits for alternately supplying sustain pulses to the sustain electrodes X. The scan electrodes Y and the X electrodes X are alternately applied with the sustain pulses.

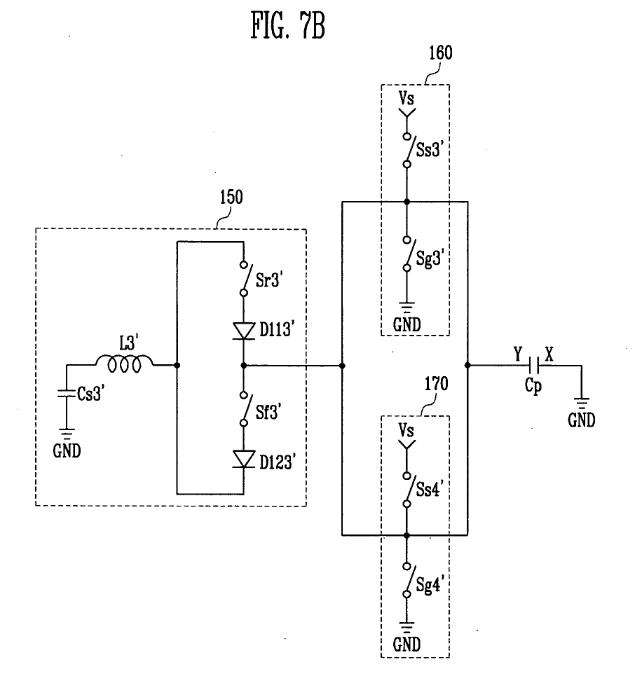

FIGS. 7A and 7B are schematic circuit diagrams illustrating driving circuits according to embodiments of the present invention.

In FIG. 7A, only the driving circuit coupled to the scan electrodes Y is illustrated. However, the driving circuit coupled to the sustain electrodes X may have the same or similar structure as the driving circuit coupled to the scan electrodes Y.

Referring to FIG. 7A, the driving circuit according to an embodiment of the present invention includes an energy recovery circuit 150, a first sustain circuit 160, and a second sustain circuit 170.

The energy recovery circuit 150 is commonly coupled to the first sustain circuit 160 and the second sustain circuit 170, and supplies or recovers energy through the first sustain circuit 160 or the second sustain circuit 170.

Therefore, the energy recovery circuit 150 includes an inductor L3 that is commonly coupled to the first sustain circuit 160 and the second sustain circuit 170, a rising switch Sr3 and a falling switch Sf3 coupled in parallel between the inductor L3 and the source capacitor Cs3, a first diode D113 positioned between the rising switch Sr3 and the inductor L3, and a second diode D123 coupled between the falling switch Sf3 and the source capacitor Cs3.

The voltage charged in the source capacitor Cs3 corresponds to 1/2 of the sustain voltage Vs. The rising switch Sr3 is turned on when the voltage charged in the source capacitor Cs3 is supplied to the panel capacitor Cp. The falling switch Sf3 is turned on when the voltage charged in the panel capacitor Cp is supplied to the source capacitor Cs3. The inductor L3 forms a resonance circuit with the panel capacitor Cp. With the first diode D 113, a current can flow from the rising switch Sr3 to the inductor L3. With the second diode D123, a current can flow from the falling switch Sf3 to the source capacitor Cs3.

The first sustain circuit 160 and the second sustain circuit 170 supply the sustain voltage Vs or the ground voltage GND to the scan electrodes Y. The first sustain circuit 160 and the second sustain circuit 170 are alternately driven.

Each of the first sustain circuit 160 and the second sustain circuit 170 includes a sustain switch (Ss3 and Ss4) coupled between the panel capacitor Cp and the sustain power source Vs, and a ground switch (Sg3 and Sg4) coupled between the panel capacitor Cp and the ground power source GND.

The sustain switch (Ss3 or Ss4) is turned on when the sustain voltage Vs is supplied to the panel capacitor Cp. The ground switch (Sg3 and Sg4) is turned on when the ground power source GND is supplied to the panel capacitor Cp.

The operations of the driving circuit of FIG. 7A will now be further described. First, the rising switch Sr3 is turned on so that a voltage that increases to about the sustain voltage Vs is supplied to the panel capacitor Cp. Then, the sustain switch Ss3 included in the first sustain circuit 160 is turned on so that the sustain voltage Vs is supplied to the panel capacitor Cp.

After the sustain voltage Vs is supplied to the panel capacitor Cp, the falling switch Sf3 is turned on. When the falling switch Sf3 is turned on, the voltage charged in the panel capacitor Cp is recovered to the source capacitor Cs3. At this time, the source capacitor Cs3 is charged with the voltage of Vs/2. After the voltage is charged in the source capacitor Cs3, the ground switch Sg3 included in the first sustain circuit 160 is turned on so that the ground voltage is supplied to the panel capacitor Cp.

When a next sustain pulse is supplied, the ground switch Sg3 included in the first sustain circuit 160 is turned off and the rising switch Sr3 is turned on. When the rising switch Sr3 is turned on, the voltage that increases to about the sustain voltage is supplied to the panel capacitor Cp. Then, the sustain switch Ss4 included in the second sustain circuit 170 is turned on so that the sustain voltage Vs is supplied to the panel capacitor Cp.

After the sustain voltage Vs is supplied to the panel capacitor Cp, the falling switch Sf3 is turned on. When the falling switch Sf3 is turned on, the voltage charged in the panel capacitor Cp is recovered to the source capacitor Cs3. At this time, the source capacitor Cs3 is charged with the voltage of Vs/2. After the voltage is charged in the source capacitor Cs3, the ground switch Sg4 included in the second sustain circuit 170 is turned on so that the ground voltage is supplied to the panel capacitor Cp.

The first sustain circuit 160 and the second sustain circuit 170 repeat the above-described operations to alternately supply the sustain pulses to the scan electrodes Y. As described above, when the first sustain circuit 160 and the second sustain circuit 170 are alternately driven, their switching frequencies are reduced by 1/2 so that their switching losses can be minimized or reduced.

For example, when the driving circuit is driven at the switching frequency of 200 KHz, the first sustain circuit 160 and the second sustain circuit 170 are driven at the switching frequency of 100 KHz to alternately supply the sustain pulses. Therefore, their switching losses can be minimized or reduced.

Furthermore, although the driving circuit of the sustain electrodes X is not illustrated in FIG. 7A, the driving circuit of the sustain electrodes X can be designed to have the same or similar structure as that of the driving circuit of the scan electrodes Y.

In the embodiment of FIG. 7A, since the energy recovery operation is performed by a common energy recovery circuit 150, unlike the embodiments of FIGS. 4A and 4B, it is difficult to make the rising and falling shapes of the sustain waveforms to be different from each other so that the degree of freedom of the design of the waveforms is reduced. However, since the embodiment of FIG. 7A employs less circuit elements, it is possible to reduce the cost of manufacturing the driving circuit.

The differences between the driving circuit illustrated in FIG. 7B and the one illustrated in FIG. 7A are the circuit configurations of their respective energy recovery circuits 150. In FIG. 7B, the inductor L3′ is coupled between the source capacitor Cs3′ and the rising switch Sr3′ and the falling switch Sf3′. Since the driving circuits of FIGS. 7A and 7B operate under substantially the same principle, a detailed description of the operation of the driving circuit of FIG. 7B will be omitted.

In the above-described exemplary embodiments, a method of driving the sustain circuits at 1/2 of the desired sustain switching frequency using two sustain circuits is described. However, those skilled in the art will understand that a method of driving the sustain circuits at switching frequency of 1/n (n is no less than 3) of the desired sustain switching frequency can be performed using no less than 3 sustain circuits.

Although exemplary embodiments of the present invention have been shown and described, it would be appreciated by those skilled in the art that changes may be made in these embodiments without departing from the principles and spirit of the present invention, the scope of which is defined in the claims and their equivalents.

What is claimed is:

1. A plasma display device comprising a first electrode, a second electrode parallel to the first electrode, and a third electrode crossing the first electrode and the second electrode, and a driver for applying a plurality of sustain pulses at a sustain frequency to the first electrode during a sustain period, the driver comprising:
a first driving circuit for applying a first portion of the plurality of sustain pulses to the first electrode; and
a second driving circuit for applying a second portion of the plurality of sustain pulses to the first electrode,
wherein the first portion and the second portion of the plurality of sustain pulses have the same polarity, and
wherein the first driving circuit and the second driving circuit are configured to apply the first portion and the second portion, respectively, at different time.

2. The plasma display device of claim 1,
wherein the first driving circuit and the second driving circuit are configured to apply the first portion and the second portion, respectively, at frequencies less than the sustain frequency.

3. The plasma display device of claim 1, wherein each of the first driving circuit and the second driving circuit comprises:
a first switch having a first terminal coupled to a first power and a second terminal coupled to the first electrode; and
a second switch having a first terminal coupled to the first electrode and a second terminal coupled to a second power.

4. The plasma display device of claim 3, wherein the first power provides a sustain voltage.

5. The plasma display device of claim 3, wherein the second power provides a ground voltage.

6. The plasma display device of claim 1, the driver further comprising a first energy recovery circuit coupled to the first electrode.

7. The plasma display device of claim 6, wherein the first energy recovery circuit comprises:
a capacitor having a first terminal coupled to a ground voltage and a second terminal;
an inductor having a first terminal coupled to the first electrode and a second terminal;
a first switch having a first terminal coupled to the second terminal of the capacitor and a second terminal coupled to the second terminal of the inductor; and
a second switch having a first terminal coupled to the second terminal of the inductor and a second terminal coupled to the second terminal of the capacitor.

8. The plasma display device of claim 6, wherein the first energy recovery circuit comprises:
a capacitor having a first terminal coupled to a ground voltage and a second terminal;
an inductor having a first terminal coupled to the second terminal of the capacitor and a second terminal;
a first switch having a first terminal coupled to the second terminal of the inductor and a second terminal coupled to the first electrode; and
a second switch having a first terminal coupled to the second terminal of the inductor and a second terminal coupled to the first electrode.

9. The plasma display device of claim 6, wherein the first energy recovery circuit is coupled to the first electrode through each of the first and second driving circuits.

10. The plasma display device of claim 9, wherein the first portion and the second portion of the plurality of sustain pulses are alternately applied to the first electrode.

11. The plasma display device of claim 6, the driver further comprising a second energy recovery circuit coupled to the first electrode.

12. The plasma display device of claim 11, wherein the second energy recovery circuit has a substantially same circuit constitution as the first energy recovery circuit, and
wherein the first energy recovery circuit and the first driving circuit are configured to generate the first portion of the plurality of sustain pulses.

13. The plasma display device of claim 11, wherein the second energy recovery circuit and the second driving circuit are configured to generate the second portion of the plurality of sustain pulses.

14. A method of driving a plasma display device in a sustain period at a sustain frequency, the plasma display device comprising a first electrode, a second electrode parallel to the first electrode, and a third electrode crossing the first electrode and the second electrode, the method comprising:
applying a first sustain pulse generated from a first driving circuit of the plasma display device to a first electrode;
applying a second sustain pulse generated from a second driving circuit of the plasma display device to the first electrode, the second sustain pulse applied to the first electrode at a time different from that of the first sustain pulse,
wherein the first sustain pulse and the second sustain pulse have the same polarity.

15. The method of claim 14, further comprising:
applying the first sustain pulse to the first electrode during the sustain period at a first frequency that is less than the sustain frequency; and
applying the second sustain pulse to the first electrode during the sustain period at a second frequency that is less than the sustain frequency.

16. The method of claim 14, wherein a summation of the first frequency and the second frequency is equal to the sustain frequency.

17. The method of claim 14, wherein each of the first frequency and the second frequency is equal to one half of the sustain frequency.

18. The method of claim 14, wherein the first frequency is equal to the second frequency.

19. The method of claim 14, wherein the first sustain pulse and the second sustain pulse are alternately applied to the first electrode.

20. A plasma display device comprising a first electrode, a second electrode parallel to the first electrode, a third electrode crossing the first electrode and the second electrode, and a driver for applying a plurality of sustain pulses at a sustain frequency to the first electrode during a sustain period, the driver comprising:
a first driving circuit for applying a first portion of the plurality of sustain pulses to the first electrode; and
a second driving circuit for applying a second portion of the plurality of sustain pulses to the first electrode, the second portion applied to the first electrode at a time different from that of the first portion,
wherein the first driving circuit and the second driving circuit are coupled in parallel with respect to the first electrode.

21. The plasma display device of claim 20, wherein an output voltage range of the first driving circuit is substantially equal to that of the second driving circuit.

22. The plasma display device of claim 20, wherein the first driving circuit and the second driving circuit are non-switchably coupled to the first electrode.
